(19) United States
(12) Patent Application Publication
(10) Pub. No.: US 2025/0205735 A1
(43) Pub. Date: Jun. 26, 2025

(54) METHOD FOR MANUFACTURING A TRANSPARENT OR TRANSLUCENT VEHICLE PART

(71) Applicant: OPmobility SE, Lyon (FR)

(72) Inventor: Gérald ANDRE, Sainte-Julie (FR)

(73) Assignee: OPmobility SE, Lyon (FR)

(21) Appl. No.: 18/989,506

(22) Filed: Dec. 20, 2024

(30) Foreign Application Priority Data
Dec. 22, 2023 (FR) FR2315193

(51) Int. Cl. B05D 3/06; B23K 26/362

(52) U.S. Cl. CPC B05D 3/06; B23K 26/362

(57) ABSTRACT

A method for manufacturing a motor vehicle body part, the method includes depositing at least one opaque coating on at least part of one face of a main body of the body part, the main body being made of transparent or translucent plastic, and producing a set of microperforations in the opaque coating by removing the opaque coating using a laser beam locally irradiating the opaque coating, an irradiation trajectory of the laser beam consisting solely of substantially rectilinear successive trajectory lines.

The invention relates to a motor vehicle part. More particularly, the invention relates to a method for manufacturing a transparent or translucent vehicle part which contributes to the external appearance of the vehicle and a device for carrying out such a method.

A vehicle comprises several transparent or translucent parts intended to transmit light. These include parts used for regulatory lighting purposes, such as those protecting the headlamp units of high and low beam headlamps or indicator lights. Moreover, the vehicle may also feature light sources intended for decorative purposes which enhance the aesthetics of the vehicle.

For these purposes, it is possible to treat an outer surface or an inner face of transparent or translucent plastic parts to improve the appearance thereof. One way of doing this is to overmold an opaque film or mask onto the outer surface of the part, the opaque film having a predefined pattern allowing light to pass through. In this way, when the light source associated with the part emits light, said light is partially blocked by the opacity of the opaque film and partially transmitted by the parts of the part facing the pattern. This improves the aesthetics of the light beam transmitted by the transparent or translucent part from the light source to the external environment. An opaque film as described hereinbefore can cause color-matching problems with the paintwork of other parts of the vehicle, which has a negative impact on the aesthetics of the vehicle.

It is also known to paint the outer or inner face of a transparent or translucent body panel and then remove a greater or lesser part of the deposited paint layer, for example by providing microperforations or zones of greater size using a laser on the paint layer in order to free zones of any paint and make them transparent or translucent. The desired aim is to allow a light to pass through from behind the bodywork part.

In the case of microperforations, these are dimensioned and distributed over the body panel in such a way as to allow a visible light emitted from an inner face of the body panel to pass through to the outside of the body panel while not making it possible, when the light source(s) is (are) switched off, to see through the body panel from outside the vehicle while maintaining an overall appearance close to that of a painted body part without removing paint from the body part due to the small size of the microperforations.

Microperforations performed using a laser are typically substantially circular in shape and the number of microperforations can be relatively large on a treated surface. In fact, the zones able to allow light through can measure from a few centimeters to several tens of centimeters and the microperforations can have a size ranging from 20 to 1000 micrometers, preferably between 50 and 700 micrometers, more preferably between 100 and 300 micrometers, and can be spaced apart by a distance of between 1 and 4 times the size of the microperforations, preferably between 2 and 3 times the size of the microperforations, preferably substantially equal to 2 times the size of the microperforations. The production of very large numbers of circular microperforations has several disadvantages:
The cycle time per microperforation performed is quite long, this being due to the circular shape of the microperforations. Typically, this shape is obtained by the laser producing concentric circles, or by circular scanning of the circle contour by the laser and then scanning by rectilinear trajectories within the defined contour. Both of these options lead to having a high cycle time per microperforation. Given the large number of microperforations that can be made on a panel to obtain the desired visual effect (taking into account the size of the microperforations and the spacing thereof over a surface as described hereinbefore), and which can be at least 4 microperforations per mm², i.e. 40,000 microperforations over a 100-mm square surface, the cycle time to obtain the final body panel can be long (the problem of the long cycle time arises when at least 5,000 to 10,000 microperforations are made, even though a cycle time of less than 5 minutes, preferably between 1 and 2 minutes, is desired).
The programming of the robot carrying the laser is quite complex, which leads to heavy programming files that are difficult for the machine to process.

One of the aims of the invention is to remedy these problems by proposing a method for reducing the cycle time for producing microperforations, and therefore the cycle time for manufacturing the final decorated panel.

To this end, the invention relates to a method for manufacturing a motor vehicle body part comprising the following steps:
depositing at least one opaque coating on at least part of one face of a main body of the body part, the main body being made of transparent or translucent plastic, and
producing a set of microperforations in the opaque coating by removing the opaque coating using a laser beam locally irradiating the coating, an irradiation trajectory of the laser beam consisting solely of substantially rectilinear successive trajectory lines.

“Transparent”, respectively “translucent”, means that a part is at least transparent, respectively translucent, to any light radiation having a wavelength within the visible spectrum, that is, between approximately 380 and 780 nm, or to any infrared radiation, that is, a wavelength between approximately 780 nm and 1 mm.

Microperforations are defined as a removal of the layer of paint whose largest irradiated surface dimension is between 20 and 1000 μm, preferably between 50 and 700 μm, preferably between 100 and 300 μm.

“Local irradiation” means a removal of material over the entire thickness of the coating. The coating may be a paint, for example in three layers (a 5 to 20 μm thick primer, a 10 to 40 μm thick base and a 25 to 40 μm thick varnish, i.e. a total thickness of between 40 and 100 μm), a metallization coating with a thickness that can be between 1 and 5 μm, a printed ink, a coating deposited by pad printing or by screen printing, a film applied to the body part (and comprising ink, paint, etc.), and so on. Laser irradiation allows the coating to be removed over the entire thickness thereof (or the coating present on the film in the case of application of a film, with the film acting as the coating substrate), for example in a thickness range of between 1 and 100 μm for the thickness examples hereinbefore.

Thus, producing microperforations solely by irradiation trajectories comprising only substantially rectilinear trajectory lines saves time by simplifying the trajectory compared with a much more complex prior art trajectory and mixing rectilinear and curved lines. In addition, programming a trajectory comprising only rectilinear displacements is less complex to achieve and more easily processed by a machine than that according to the prior art.

According to other optional features of the manufacturing method, taken alone or in combination:
the irradiation trajectory comprises at least in part the repetition of a same trajectory line pattern composed of several substantially rectilinear successive trajectory lines;
at least one trajectory line is composed of irradiation sections and of non- irradiation sections of the opaque coating so as to allow at least some of several microperforations to be produced;
a focal length between an emission source of the laser beam and the face of the body part is greater than or equal to between 100 and 1000 millimeters, preferably between 300 and 700 millimeters, preferably between 400 and 600 millimeters;
the focal length between the emission source of the laser beam and the face of the body part is modified within the irradiation trajectory of the face of the body part;
at least some of the microperforations are substantially parallelogram- shaped, preferably substantially square or substantially rectangular;
a scanning band width of the laser beam on the face of the body part is between 40 and 200 μm, preferably between 70 and 120 μm, preferably substantially equal to 100 μm
the opaque coating is formed by at least one layer of paint, a printed ink, a metallization coating, a coating deposited by pad printing or by screen printing;

The invention also relates to a method for manufacturing a motor vehicle body part comprising:
at least one member for depositing at least one opaque coating on at least part of one face of a main body of the body part, the main body being made of transparent or translucent plastic, and
at least one emission source of a laser beam configured to produce a set of microperforations in the opaque coating by removing the opaque coating using a laser beam locally irradiating the opaque coating, the emission source of the laser beam being configured to produce an irradiation trajectory of the laser beam consisting solely of substantially rectilinear successive trajectory lines.

Advantageously, the emission source of the laser beam is configured to vary the focal length between the emission source of the laser beam and the face of the body part during irradiation of the face of the body part.

### BRIEF DESCRIPTION OF THE FIGURES

The invention will be better understood upon reading the following description, which is provided merely as example and with reference to the appended drawings, wherein:

FIG. 1 is a view of a body panel comprising microperforations produced by a method according to the invention,

FIG. 2 is a view of a portion of a zone comprising microperforations produced by a method according to the invention,

FIG. 3 is a representation of a microperforation produced by a method according to a first embodiment of the invention,

FIG. 4 is a representation of a microperforation produced by a method according to a second embodiment of the invention, and

FIG. 5 is a representation of a set of microperforations comparable to the microperforation in FIG. 4.

### DETAILED DESCRIPTION

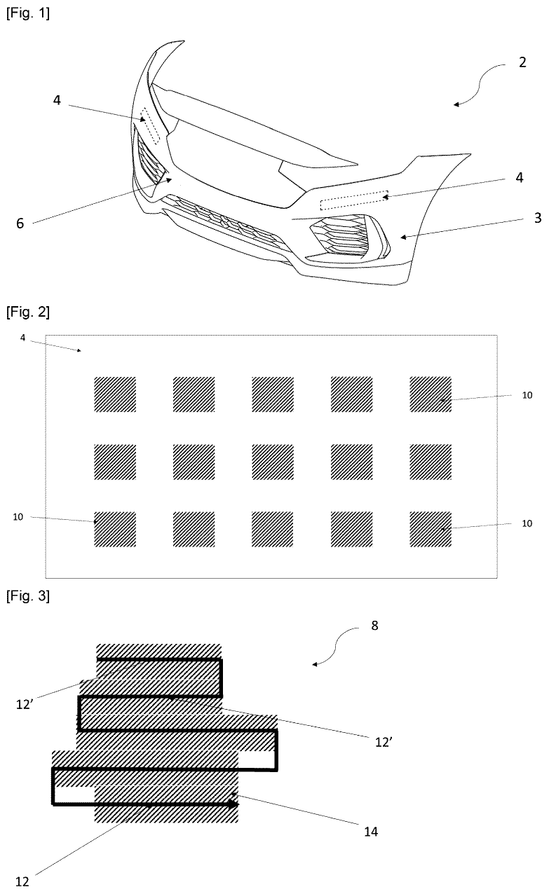

FIG. 1 shows a body part 2 comprising a transparent or translucent main body 3 and zones 4 of microperforations produced by a method according to the invention, while FIG. 2 shows a portion of a zone 4 of microperforations comprising a set of microperforations (herein second microperforations 10 as described below).

In the example shown in FIG. 1, the body part 2 is a front bumper. Of course, it may also be any other body part, for example a tailgate, a grille, a rear bumper, etc. It could also be an attachment to a body panel.

The body part 2 in FIG. 1 comprises two zones of microperforations. Of course, the number of microperforation zones 4 may be different, as may the size(s) of the microperforation zones 4. The microperforation zones 4 may be of the same or different sizes, comprise a greater or lesser number of microperforations, etc.

The microperforation zones 4 can be produced on an outer face 6 and/or on an inner face (not shown in FIG. 1) of the body part 2. Outer face 6 means the face of the body part 2 that is visible from outside the vehicle when the body part 2 is mounted on a vehicle. Inner face means the face of the body part 2 opposite the outer face 36, and not visible from outside the vehicle when the body part 2 is mounted on a vehicle.

The microperforations of a zone 4 of microperforations are distributed at microperforation zone 4 (FIG. 2 shows three lines of five microperforations), have a different shape(s), a transparency (or translucency) allowing the passage of radiation emitted by a source of visible light or infrared radiation and emitted from the back of the body part 2 (i.e. facing the inner face of the body panel 2), while not making it possible to see through the body panel 2, particularly when a source of visible light is inactive. As a reminder, “transparent” or “translucent” respectively means that a part is at least transparent, respectively translucent, to any light radiation having a wavelength in the visible spectrum, that is, between approximately 380 and 780 nm, or to any infrared radiation, that is, with a wavelength between approximately 780 nm and 1 mm. The visible light source is preferably an optical device comprising light-emitting diodes (LEDs). The infrared radiation source may be a LIDAR.

The body part 2 is made of a material that is transparent or translucent to light, such as, by way of example and not exclusively:
polycarbonate (PC),
polymethyl methacrylate (PMMA),
acrylonitrile butadiene styrene (ABS) or styrene acrylonitrile (SAN), acrylonitrile styrene acrylate (ASA) and mixtures thereof,
amorphous polyolefins such as cyclic olefin copolymers (COC) or cyclic olefin polymers (COP),
polyethylene terephthalate (PET),
polypropylene (PP),
polyamide (PA),
polybutylene terephthalate (PBT),
polyurethane (PU), and
polyvinyl chloride (PVC).

The method for producing the body part 2 (for example, injection or thermoforming) or even the dimensions and shapes of the body part 2 are known to the person skilled in the art and will not be described in detail herein.

The manufacturing method according to the invention comprises the following steps:
Depositing at least one opaque coating on at least part of one face of the main body 3 of the body part 2. This could for example be a paint (composed of a single layer or of several layers), an ink, etc., as described previously. Typically, it is a coating that does not allow visible light or infrared radiation emitted by the source placed behind the body part 2 to pass through and from which it is possible to locally remove the layer or layers of opaque material using a laser beam. This deposition can be applied to the outer face 6 or to the inner face of the body part 2.
Producing a set of microperforations in the opaque coating by removing the opaque coating using a laser beam locally irradiating the opaque coating, an irradiation trajectory of the laser beam consisting solely of substantially rectilinear successive trajectory lines. In the context of the invention, a laser beam irradiates part of the opaque coating to carry out a total removal, in the thickness (according to the definition provided previously), of the opaque coating at microperforation zone(s) 4 of this latter in order to obtain transparent or translucent microperforations as described hereinbefore. This removal of the opaque coating reveals the main body 3, which is itself transparent or translucent. Visible light or infrared radiation will therefore be able to pass through the body part 2, herein the body panel 2, at the microperforations.

The size of the microperforations and the arrangement thereof in relation to one another (for example the distance between two adjacent microperforations) are selected so as to achieve the desired effect described hereinbefore, namely, to allow the emitted radiation to pass through without being able to see through the body part 2 from the outside, particularly when a visible light source is switched off. The source of the laser beam is configured to produce microperforations of the desired shape(s) and size(s), the desired spacing between the microperforations or even a desired transparency of the microperforations. The parameters set include the following:
The focal length between the source of the laser beam and the body part 2.
The power of the laser beam.
The scanning speed of the microperforation zones 4.
The exposure time of a zone to be irradiated with a laser beam.
Whether or not trajectory lines overlap, and the percentage of overlap between trajectory lines.
Alternating or non-alternating trajectory lines corresponding to irradiation or non-irradiation, or the presence of irradiation and non-irradiation sections within a same trajectory line.
The laser frequency when the laser is a pulsed laser.
The wavelength of the laser source.

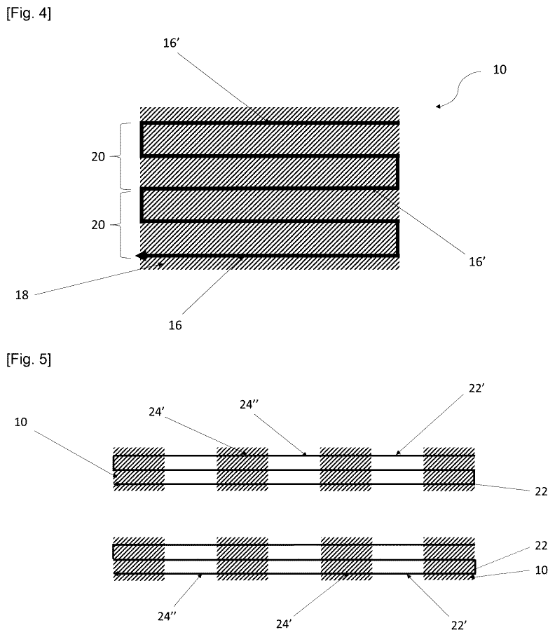

FIGS. 3 and 4 show two microperforations 8 and 10 of different shapes. FIG. 3 shows a first microperforation 8 according to a first embodiment of the invention, herein of any shape. A first trajectory 12, comprising only substantially rectilinear first trajectory lines 12′ (two referenced on FIG. 3), is used to obtain the first microperforation 8. The first trajectory 12 consists of several first trajectory lines 12′, which may or may not be similar and which make it possible to obtain a first irradiated surface 14, forming the first microperforation 8.

FIG. 4 shows a second microperforation 10 according to a second embodiment of the invention. A second trajectory 16, comprising only substantially rectilinear second trajectory lines 16′ (two referenced in FIG. 4), is used to obtain the second microperforation 10. The second trajectory 16 consists of several trajectory lines having substantially identical and aligned sections in order to obtain a second irradiated zone 18 of rectangular shape.

According to the second embodiment of the invention, the irradiation trajectory (herein the second irradiation trajectory 16) comprises at least in part the repetition of a same trajectory line pattern 20 composed of several rectilinear successive trajectory lines (herein the second trajectory lines 16′) (two successive patterns 20 are referenced in FIG. 1). Repeating a same pattern further simplifies the programming of the movements of the laser beam source.

FIG. 5 shows a set of second microperforations 10 forming two groups of aligned second microperforations 10. Together, these eight perforations 10 form at least a portion of a microperforation zone 4. In this example, a third trajectory line 22 is used to create a whole line of second microperforations 10. Of course, the number of trajectories to produce a set of microperforations can vary. It would be possible, for example, to produce all the microperforations shown in FIG. 5 via a single trajectory.

Like the first and second trajectories 12 and 16, the third trajectory 22 consists of rectilinear third trajectory lines 22′. However, at least part of the third trajectory lines 22′ (the horizontal trajectory lines in FIG. 4) comprise irradiation sections 24′ and non-irradiation sections 24″. In this embodiment, the alternation of irradiation sections 24′ and non-irradiation sections 24″ means that at least a third trajectory line 22′ (the horizontal trajectory lines in FIG. 4) allows at least some of several second microperforations 10 to be produced. In the example shown in FIG. 4, all the third horizontal trajectory lines 22′ are involved in producing the second microperforations 10 of a same group of microperforations alternating irradiation 24′ and non-irradiation 24″ sections. Aligning at least some of the second microperforations 10 makes it easier to share the production of said microperforations.

Preferably, the focal length between an emission source of the laser beam and the face of the body part is between 100 and 1000 millimeters, preferably between 300 and 700 millimeters, preferably between 400 and 600 millimeters. The use of a long focal length means that a point of impact of the laser beam on the body part 2 is larger, and therefore limits the number and/or amplitude of movements of the laser beam to be implemented to produce one or more microperforations. A large focal length also allows a larger zone of the body part 2 to be scanned simply by moving the lens(es) of the laser source without having to move the source of the laser beam too often from one zone to be scanned to another (displacement required when the source of the laser beam reaches its spatial limit for processing a zone of the body part 2 simply by moving the lens). Preference is therefore given to an angular displacement of the laser beam whereas a laser beam source carrier, for example a robot arm, is fixed. The displacements of the carrier are thus limited by increasing the surface area that can be irradiated simply by moving the lens of the laser beam source. It is even possible to reduce the number of laser beam sources to be used to treat a given surface area within a given time frame to be respected.

It is possible to produce a microperforation shape that can be easily achieved by a trajectory according to the invention, in order to further reduce the manufacturing time of the body part 2. At least some of the microperforations have a shape in which at least one side is parallel to a trajectory line. This is the case for the microperforations shown in FIGS. 2 to 5. Preferably, at least some of the microperforations are substantially parallelogram-shaped, preferably square or substantially rectangular. These are very simple shapes to produce using the method according to the invention, as demonstrated by the simple irradiation trajectories in FIGS. 3 and 4. As explained above, it may be advantageous to have a fairly large point of impact of the laser beam on the face of the body part for the reasons mentioned hereinbefore (increasing the size of an irradiated surface by simple angular movements of the lens). More generally, it is interesting to determine a size of the impact point that optimizes the scanning of a zone to be irradiated, while ensuring a size that produces microperforations of the desired shape, while respecting irradiation speeds, irradiation times or even the overlap between two irradiation trajectory lines. For this purpose, the width of a scanning band of the laser beam on the face of the body part is between 40 and 200 μm, preferably between 70 and 120 μm, preferably substantially equal to 100 μm

The invention also relates to a device for manufacturing a vehicle part comprising:
At least one member for depositing at least one opaque coating on at least part of one face of a main body 3 of the body part 2, the main body 3 being made of transparent or translucent plastic. This could be a paint application robot, or even means for depositing an opaque film.
At least one emission source of a laser beam configured to produce a set of microperforations in the opaque coating by removing the opaque coating using a laser beam locally irradiating the opaque coating, the emission source of the laser beam being configured to produce an irradiation trajectory of the laser beam consisting solely of substantially rectilinear successive trajectory lines.

Advantageously, the emission source of the laser beam is configured to be able to vary the focal length between the emission source of the laser beam and the face of the body part 2 during irradiation of the face of the body part 2, for the reasons mentioned hereinbefore.

### LIST OF REFERENCES

2: Body part
3: Main body
4: Zones of microperforations
6: Outer face
8: First microperforation
10: Second microperforation
12: First trajectory
12′: First trajectory lines
14: First irradiated surface
16: Second trajectory
16′: Second trajectory lines
18: Second irradiated surface
20: Trajectory line patterns
22: Third trajectory
22′: Third trajectory lines
24: Irradiation sections
24″: Non-irradiation sections

1. A method for manufacturing a motor vehicle body part comprising the following steps:
depositing at least one opaque coating on at least part of one face of a main body of the body part, the main body being made of transparent or translucent plastic, and
producing a set of microperforations in the opaque coating by removing the opaque coating using a laser beam locally irradiating the opaque coating, an irradiation trajectory of the laser beam consisting solely of substantially rectilinear successive trajectory lines.

2. The manufacturing method according to claim 1, wherein the irradiation trajectory comprises at least in part the repetition of a same trajectory line pattern composed of several substantially rectilinear successive trajectory lines.

3. The manufacturing method according to claim 1, wherein at least one trajectory line is composed of irradiation sections and non-irradiation sections of the opaque coating so as to allow at least some of several microperforations to be produced.

4. The manufacturing method according to claim 1, wherein a focal length between an emission source of the laser beam and the face of the body part is greater than or equal to between 100 and 1000 millimeters, preferably between 300 and 700 millimeters, preferably between 400 and 600 millimeters.

5. The manufacturing method according to claim 1, wherein the focal length between the emission source of the laser beam and the face of the body part is modified within the irradiation trajectory of the face of the body part.

6. The manufacturing method according to claim 1, wherein at least some of the microperforations are substantially parallelogram-shaped, preferably substantially square or substantially rectangular.

7. The manufacturing method according to claim 1, wherein a width of a scanning band of the laser beam on the face of the body part is between 40 and 200 μm, preferably between 70 and 120 μm, preferably substantially equal to 100 μm.

8. The manufacturing method according to claim 1, wherein the opaque coating is formed by at least one layer of paint, a printed ink, a metallization coating, a coating deposited by pad printing or by screen printing.

9. A device for manufacturing a motor vehicle body part comprising:
at least one member for depositing at least one opaque coating on at least part of one face of a main body of the body part, the main body being made of transparent or translucent plastic, and
at least one emission source of a laser beam configured to produce a set of microperforations in the opaque coating by removing the opaque coating using a laser beam locally irradiating the opaque coating, the emission source of the laser beam being configured to produce an irradiation trajectory of the laser beam consisting solely of substantially rectilinear successive trajectory lines.

10. The manufacturing device according to claim 9, wherein the emission source of the laser beam is configured to vary the focal length between the emission source of the laser beam and the face of the body part during irradiation of the face of the body part.
